(19) United States
(12) Patent Application Publication
(10) Pub. No.: US 2008/0176006 A1
(43) Pub. Date: Jul. 24, 2008

(54) COATING FILM DRYING METHOD

(75) Inventors: Minoru Yamamoto, Kariya-shi (JP); Kenji Io, Motosu-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/955,848

(22) Filed: Dec. 13, 2007

(30) Foreign Application Priority Data
Jan. 23, 2007 (JP) 2007-012794

(51) Int. Cl. B05D 3/06; B05D 3/02

(52) U.S. Cl. 427/542; 427/374.1; 427/346

(57) ABSTRACT

A coating film drying method includes a coating process for applying a waterborne coating to a work and forming a coating film on the work, so that a coated member is produced from the work, a preliminary drying process for heating the coated member and preliminarily drying the coated member until a nonvolatile content of the coating film reaches a percentage ranging from 70% to 90%, a final drying process for heating and drying the coated member until the nonvolatile content of the coating film reaches a percentage of 97% or more and a cooling process for cooling the coated member until a surface temperature of the coated member is decreased to a temperature at which the coated member is touchable by hand, whereby the preliminary drying process is carried out by repeatedly heating and cooling the coated member at a predetermined frequency to preliminarily dry the coating film.

### CROSS REFERENCE TO RELATED APPLICATIONS

This application is based on and claims priority under 35 U.S.C. §119 to Japanese Patent Application 2007-012794, filed on Jan. 23, 2007, the entire content of which is incorporated herein by reference.

### FIELD OF THE INVENTION

The present invention relates to a coating film drying method by use of waterborne coatings, and more particularly to a coating film drying method, which includes a process for preliminarily drying a coating film.

### BACKGROUND

In recent years, a transition of coatings from solvent-borne coatings to waterborne coatings has been required due to global environmental issues. For example, the automobile industry has proceeded with replacement of coatings for vehicle bodies or bumpers from solventborne coatings to waterborne coatings.

A waterborne coating is dried by use of hot air, a heater, or the like in a drying process. A coating film formed of the waterborne coating is dried by externally applying heat. At this time, when the coating film is rapidly heated to be dried quickly for shortening processes, a surface of the coating film is firstly solidified. Thereafter, water in the coating film evaporates, leading to appearance defects referred to as popping defects. The popping defects are the appearance defects in which crater-like openings are formed on the surface of the coating film. It is necessary to heat the entire coating film as slowly as possible so as to be warmed as uniformly as possible in order to solve such popping defects. Accordingly, the drying time of the coating film disadvantageously takes longer compared to a coating film drying process by use of a solventborne coating.

Meanwhile, a coating film drying method described in JP 2003-340361A (hereinafter referred to as Patent Document 1) includes a coating process for applying an air-drying waterborne coating or a forced-drying waterborne coating to a surface of a subject work, a setting process for exposing the coated work directly at room temperature, a preliminary heating process for heating the coated work until a surface temperature of the coated work reaches a temperature ranging from 35 degrees Celsius to 60 degrees Celsius, and a drying process for heating the coated work until a nonvolatile content of a coating film of the coated work reaches a percentage of 97 percent or more. The preliminarily heating process is conducted under the condition where heating satisfies the relation of ΔNV/Δt=2% to 5.5% per minute (ΔNV: variations in a nonvolatile content during the preliminary heating process, Δt: period of the preliminary heating process). In the coating film drying method described in Patent Document 1, popping defects do not occur and the drying time is shortened.

Furthermore, another coating film drying method disclosed in JP 2004-344860A (hereinafter referred to as Patent Document 2) is conducted by preliminarily drying a coating film by irradiating microwaves to a coating film, thereby shortening the drying time.

Moreover, a coating film drying method disclosed in JP 2006-26547A (hereinafter referred to as Patent Document 3) includes a coating process for applying a waterborne coating to a subject work and forming a wet coating film with the waterborne coating on the work. The coating film drying method further includes a microwave exposure process for exposing the wet coating film to microwaves while controlling outputs of the microwaves within the range from 100 W to 500 W. In the microwave process, the wet coating film is exposed to the microwaves by controlling the outputs from the microwaves in a stepped manner, thereby shortening the drying time as well as preventing occurrence of popping defects.

However, conventionally, according to the coating film drying method described in Patent Document 1, the coated work is put into a drying furnace and is heated by use of a heating method such as air blowing, hot-air drying, and infrared heating. The coated work is directly set and not moved in the drying furnace. Accordingly, when the coated work is made of plastic material or the like being thermally deformed easily, deformation of the coated work is of concern. Further, a predetermined distance between a heating device and the coated work is required in order to prevent thermal deformation of the coated work due to spot heating thereon and in order to uniformly heat the coated work, leading to an increase of a size of the drying furnace or the like.

Moreover, conventionally, according to the coating film drying method described in Patent Document 2, when the microwaves rapidly develop heat by vibrating water molecules, water in the coating film is boiled, resulting in occurrence of popping defects. In addition, when a coating is applied to a subject work made of plastic material, the subject work generally absorbs water existing in working surroundings. Accordingly, the coated work is rapidly heated and deformed by heating with the microwaves, resulting in dimensional defects. Further, equipment for covering the coated work with an airtight metal container is required when the microwaves are applied. In the case of a coating line operated by conveyor manufacturing system, it is necessary to take out the coated work from the production line once for treatment, resulting in decreased productivity and causing a steep rise in production costs due to the requirement of expensive equipments.

Furthermore, conventionally, according to the coating film drying method described in Patent Document 3, occurrence of popping defects and deformation of the subject work are prevented by controlling the outputs from the microwaves. However, since the microwaves are applied, equipment for covering the coated work with an airtight metal container is required. In the case of a coating line operated by conveyor manufacturing system, it is necessary to take out the coated work from the production line once for treatment, resulting in decreased productivity and causing a steep rise in production costs due to the requirement of expensive equipments including the control of the outputs from the microwaves.

A need thus exists for a coating film drying method, which is not susceptible to the drawback mentioned above.

### SUMMARY OF THE INVENTION

According to an aspect of the present invention, a coating film drying method includes a coating process for applying a waterborne coating to a work and forming a coating film on the work, so that a coated member is produced from the work, a preliminary drying process for heating the coated member and preliminarily drying the coated member until a nonvolatile content of the coating film reaches a percentage ranging from 70% to 90%, a final drying process for heating and drying the coated member until the nonvolatile content of the coating film reaches a percentage of 97% or more and a cooling process for cooling the coated member until a surface temperature of the coated member is decreased to a temperature at which the coated member is touchable by hand, whereby the preliminary drying process is carried out by repeatedly heating and cooling the coated member at a predetermined frequency to preliminarily dry the coating film.

### BRIEF DESCRIPTION OF THE DRAWINGS

The foregoing and additional features and characteristics of the present invention will become more apparent from the following detailed description considered with reference to the accompanying drawings, wherein:

FIG. 1 is a process flow chart describing a coating film drying method by use of a waterborne coating according to an embodiment of the present invention;

FIG. 2 illustrates a preliminary drying device being used in a preliminary drying process according to the embodiment of the present invention;

FIG. 3 is a pattern diagram illustrating an III-III cross-section of the preliminary drying device;

FIG. 4 is a graph indicating variations in surface temperatures of coated members;

FIG. 5 describes details of Area A indicating variations in the surface temperature of the coated member in FIG. 4 when the coated member is rotated and exposed to mid-infrared rays according to the embodiment of the present invention.

### DETAILED DESCRIPTION

An embodiment of the present invention will be explained with reference to the illustrations of the drawing figures as follows.

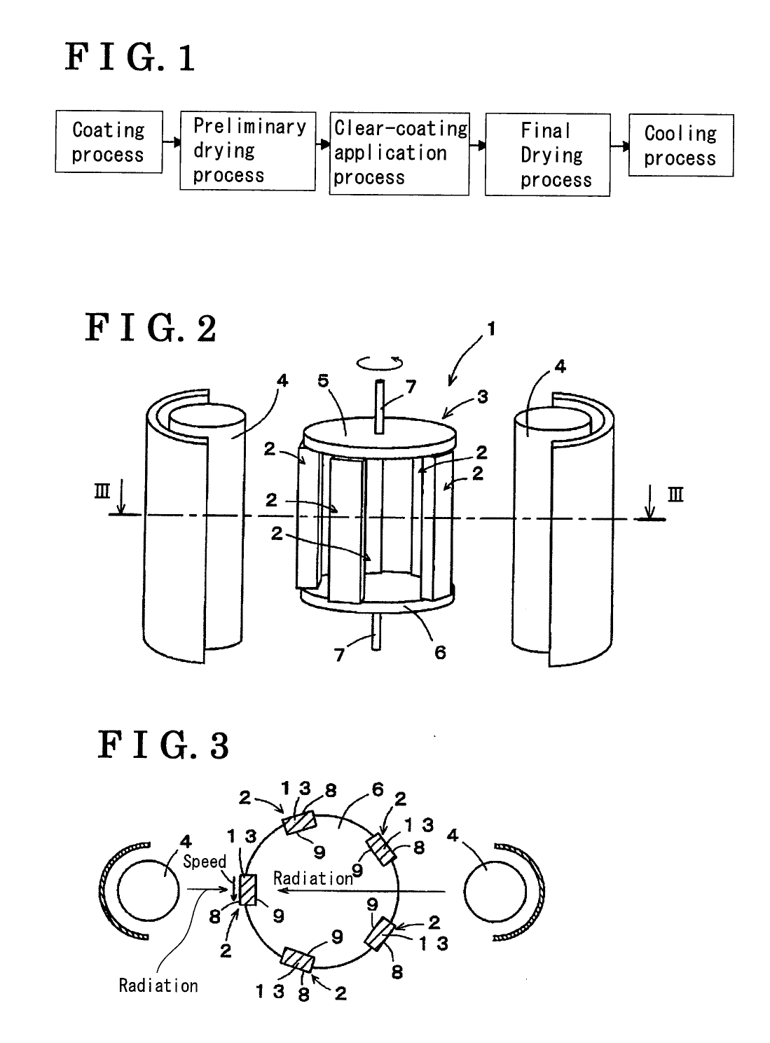

A coating film drying method for drying a coating film formed of a waterborne coating according to the embodiment will be described below based on FIGS. 1 to 6. When a subject work 13 (FIG. 3) is coated with the waterborne coating, coating films 8 and 9 (FIG. 3) are formed on surfaces of the work 13, so that a coated member 2 (FIG. 2) is produced from the work 13 having the coating films 8 and 9. The coating film drying method provides a technique for drying the coating films 8 and 9, which enables the coated member 2 to be treated in a short period of time after the coating films 8 and 9 are formed on the surfaces of the work 13. The waterborne coating applied in the technique consists primarily of acrylic emulsion and is one-liquid type cold-setting waterborne coating hardening at a temperature ranging from 70 degrees Celsius to 90 degrees Celsius. In addition, the work 13 is an automotive exterior part such as a spoiler or the like of made of plastic for a vehicle used in the automobile industry.

FIG. 1 illustrates a process flow chart of the coating film drying method by use of the waterborne coating according to the embodiment. The process flow chart includes the following five processes: a coating process, a preliminary drying process, a clear-coating application process, a final drying process, and a cooling process.

In the coating process, the coating films 8 and 9 are formed on the work 13 by applying the cold-setting waterborne coating to the work 13 of an automotive exterior part such as a spoiler for a vehicle by use of a spray coating method.

In the preliminary drying process, the coated member 2 formed by applying the coating films 8 and 9 to the work 13 is dried while being repeatedly heated and cooled. The coated member 2 is preliminarily dried until a nonvolatile content (hereinafter referred to as a NV) in each of the coating films 8 and 9 reaches a percentage ranging from 70 percent to 90 percent. Here, the percentage indication of this invention means the weight ratio.

In the clear-coating application process, a curing agent consisting primarily of isocyanate is blended in a main agent consisting primarily of acrylic urethane, thereby forming a two-liquid type cold-setting solvent coating hardening at a temperature ranging from 70 degrees Celsius to 90 degrees Celsius. Afterwards, the two-liquid type cold-setting solvent coating is applied to the coated member 2. Since design properties are required for automotive parts or the like attached to exterior surfaces for a vehicle, the coating film drying method includes the clear-coating application process between the preliminary drying process and a final drying process. Accordingly, a clear coating of the cold-setting solvent coating is applied to coating films formed of the waterborne coating.

In the final drying process, the coated member 2 is heated and dried until the NV of each of the coating films 8 and 9 reaches 97 percent or more. Since the drying time is shortened as the result of heating at high temperatures, it is preferably that heating is conducted at high temperatures unless the work 13 and the coating films 8 and 9 deteriorate. Heating by air blowing and infrared rays may be simultaneously used in order to facilitate drying.

In the cooling process, the coated member 2 is cooled until a surface temperature of the coated member 2 is decreased to a temperature at which the coated member 2 is touchable by hand. The coated member 2 may be naturally cooled but may be forcibly cooled in order to cool the coated member 2 in a short period of time. The coated member 2 is cooled until the surface temperature of the coated member 2 is decreased to a temperature at which drying properties do not substantially matter. For example, until the surface temperature of the coated member 2 is decreased to a temperature ranging from 30 degrees Celsius to 60 degrees Celsius, cooling is continued. Preferably, air blowing, cold-air cooling, or the like is conducted in order to shorten the cooling time.

FIG. 2 illustrates a preliminary drying device 1 applied in the preliminary drying process according to the embodiment. The preliminary drying device I includes a rotary device 3 for rotating the coated member 2 and a preliminary heating device 4 as heating means.

The rotary device 3 includes an upper plate 5 and a lower plate 6. The coated members 2 are supported between an outer peripheral side of the upper plate 5 and an outer peripheral side of the lower plate 6 and extend in up and down directions in FIG. 2. The upper plate 5 and the lower plate 6 are rotatably operated simultaneously with a shaft 7 in the range from 100 mm to 600 mm of the outer peripheral diameters respectively. The rotary device 3 is driven to rotate by driving means such as a motor (not shown). When the shaft 7 rotates, the coated members 2 supported by the upper plate 5 and the lower plate 6 are rotated at the same time. The rotary device 3 rotates in the range from 5 rpm to 50 rpm in the embodiment. In addition, five of the coated materials 2 may be interposed between the upper plate 5 and the lower plate 6 and equally spaced with each other on the same track on the outer peripheries of the upper plate 5 and the lower plate 6.

The preliminary heating device 4 is structured with two of 550 W to 1200 W mid-infrared heaters. Although a mid-infrared heater is applied in the embodiment, radiation type heaters other than the mid-infrared heater may be applied. In addition, the number of the preliminary heating devices 4 is not limited to two, and three or more of the preliminary heating devices 4 may be applied. When the number of the preliminary heating devices 4 is increased, the number of frequencies for heating and cooling the coated member 2 is increased.

FIG. 3 is a pattern diagram illustrating an III-III cross-section of the preliminary drying device 1 applied in the preliminary drying process according to the embodiment. A distance between the coated member 2 and the preliminary heating device 4 is varied when the coated member 2 is rotated by the rotary device 3 at a predetermined frequency raging from 0.1 Hz to 2.0 Hz, thereby repeatedly heating and cooling the coating film 8, which appears at the outer peripheral side of the rotary device 3, and the coating film 9, which appears at the inner peripheral side of the rotary device 3 as seen in FIG. 3. Accordingly, the coated member 2 is approximated to the preliminary heating device 4 in the range from 30 mm to 100 mm by repeatedly heating and cooling the coated member 2 at the predetermined frequency. Since an odd number (five) of the coated members 2 are interposed between the upper plate 5 and the lower plate 6 and equally spaced with each other on the same track on the outer peripheries of the upper plate 5 and the lower plate 6 of the rotary device 3, mid-infrared rays from the preliminary heating device 4 to the right side in FIG. 3 are irradiated to the coating film 9 that appears at the inner peripheral side of the rotary device 3 when radiant heat of the mid-infrared rays from the preliminary heating device 4 positioned to the right side in FIG. 3 is transferred straight to the coating film 9 through a space between the adjacent coated members 2.

TABLE 1
A NV of a coating film and a surface temperature of the coating
film when a speed of the coated member 2 in a rotation direction varies.

| | | Surface |
|---|---|---|
| | NV of the | temperature of |
| Speed (mm | coating | the coating film |
| per second) | film (%) | (degrees Celsius) |
| 30 | 69 | 34 |
| 40 | 71 | 36 |
| 80 | 75 | 40 |
| 160 | 79 | 42 |
| 200 | 80 | 43 |
| 250 | 80 | 43 |
| 330 | 77 | 41 |
| 400 | 70 | 38 |
| 420 | 68 | 37 |
| 500 | 58 | 33 |

The above table 1 indicates the NV of the coating film of the coated member 2 and the surface temperature of the coating film of the coated member 2 one minute after a speed of the coated member 2 in a rotation direction varied. A speed ranging from 40 mm per second to 400 mm per second is generally a speed in a low-speed rotation region. When a speed of the coated member 2 is lower than 40 mm per second, the cooling time elongates and the surface temperature of the coated member 2 increases slowly. When a speed of the coated member 2 reaches 400 mm per second or higher, the coated member 2 is cooled due to influence of convection between the rotating coated member 2 and atmospheric air, thereby increasing the surface temperature of the coated member 2 slowly. The speed of the coated member 2 ranging from 40 mm per second to 400 mm per second in the rotational direction is provided, thereby achieving the NV of the coating film of 70 percent or more one minute after the speed of the coated member 2 in the rotation direction varied. The NV of 70 percent or more is a required percentage for the preliminary heating process.

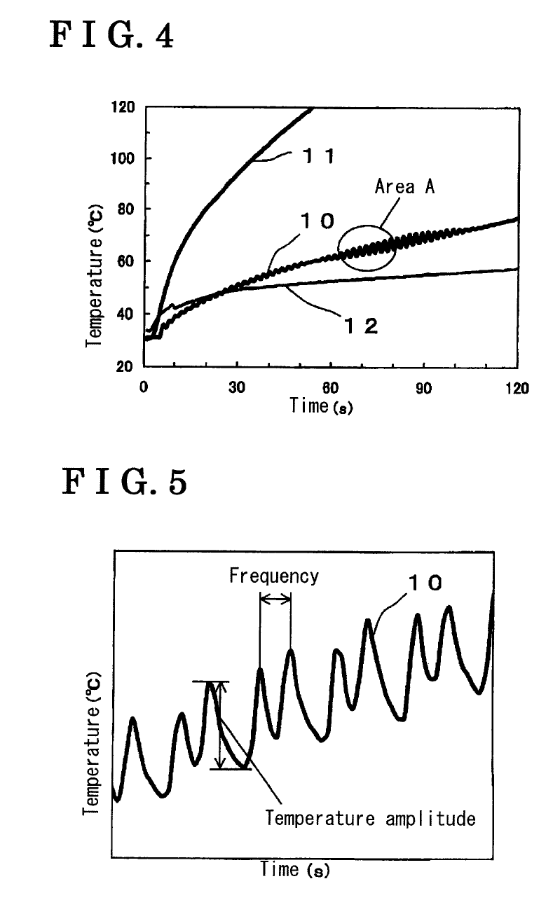

FIG. 4 is a graph indicating variations in surface temperatures of coated members, and specially indicates variations 10 (according to the embodiment) in the temperature of the coated member 2 rotated by the rotary device 3 and exposed to mid-infrared rays, variations 11 in the temperature of the coated member 2 fixed, and not rotated, and exposed to mid-infrared rays, and variations 12 in the temperature of the coated member 2 fixed, and not rotated, and exposed to hot air.

According to the embodiment, when the coated member 2 is rotated by the rotary device 3 and exposed mid-infrared rays, the coating films 8 and 9 are dried while the temperature of the coated member 2 is controlled so as not to increase in order to prevent occurrence of popping defects and deformation of the work 13 are prevented. Meanwhile, when the coated member 2 is fixed, not rotated, and exposed to mid-infrared rays, the surface temperature of the coated member 2 rapidly increases and immediately exceeds the water boiling point of 100 degrees Celsius. When the surface temperature of the coated member 2 exceeds 100 degrees Celsius, the popping defects and deformation of the work 13 may be caused. In addition, when the coated member 2 is fixed, not rotated, and exposed to hot air, heat is transferred to the coated member 2 due to hot air convection. However, the surface temperature of the coated member 2 slowly increases and preliminarily drying of the coating films 8 and 9 requires time.

FIG. 5 describes details of Area A indicating the variations 10 in the temperature of the coated member 2 rotated by the rotary device 3 and exposed to mid-infrared rays. The surface temperature of the coated member 2 repeatedly increases and decreases at the frequency ranging from 0.1 Hz to 2.0 Hz and a temperature amplitude is between 3 degrees Celsius and 20 degrees Celsius.

In the embodiment, the coating films 8 and 9 of the coated member 2 are dried by repeatedly heating and cooling the coated member 2 at the predetermined frequency (for example at the frequency ranging from 0.1 Hz to 2.0 Hz) in the preliminary drying process, thereby facilitating drying of the coating films 8 and 9 without occurrence of popping defects. Accordingly, the preliminary drying time is reduced to a period of time between 40 seconds and 150 seconds, which is below half of the drying time when an air-heating furnace is used. Moreover, a temperature of plastic material or the like included in the work 13 for the coated member 2, is controlled to be lower than momentary high temperatures of the coating films 8 and 9 by repeatedly heating and cooling the coated member 2. Accordingly, the temperature of the coated member 2 is controlled to be low while drying of the coating films 8 and 9 is facilitated without occurrence of popping defects. Consequently, thermal deformation of the work 13 due to high temperatures is prevented, thereby preventing dimensional defects.

Furthermore, a required distance between the coated member 2 and the preliminary heating device 4 for uniformly heating the coating films 8 and 9 by repeatedly heating and cooling the coated member 2 while the coated member is not rotated by the rotary device 3, is between 300 mm and 500 mm. Meanwhile, when the coated member 2 is rotated by the rotary device 3, the required distance is shortened to a length ranging from 30 mm to 100 mm, thereby downsizing the preliminary drying device 1. In addition, expensive equipment for covering the coated member 2 with an airtight metal container required when microwaves are applied is not required. When the coated member 2 is processed in the coating line operated by the conveyor manufacturing system, it is possible to process the coated member 2 in the line without taking out the coated member 2 from the line, therefore securing higher productivity compared to the conventional coating film drying method. In addition, expensive equipments are not required compared to the conventional coating film drying method, thereby reducing production costs.

Moreover, the rotary device 3 rotates so that the coated member 2 is rotated at a speed ranging from 40 mm per second to 400 mm per second relative to the preliminary heating device 4. When the coated member 2 is rotated at the speed ranging from 40 mm per second to 400 mm per second relative to the preliminary heating device 4, cooling is lightly affected by convection created by rotation of the coated member 2 and the NV (NV: nonvolatile content during a preliminary heating process) of each of the coating films 8 and 9 is maintained to 70 percent or more, which is generally suitable for preliminary drying.

In addition, since mid-infrared rays are easily absorbed in waterborne coatings, it is possible to heat water in the coating films 8 and 9. Accordingly, drying of the coating films 8 and 9 is facilitated without occurrence of popping defects and the drying time is shortened. Moreover, since the coated member 2 is heated by radiant heat of mid-infrared rays, the temperature of the coated member 2 increases from the surface in comparison to the conventional coating film drying method in which water in the coating films 8 and 9 is totally heated from within. Accordingly, the temperature of the plastic material included in the work 13 for the coated member 2 is prevented from increasing. Consequently, thermal deformation of the work 13 is prevented, thereby preventing dimensional defects.

Since a plurality of the coated materials 2 is attached to the rotary device 3 on the same track and heated by two of the preliminary heating devices 4, the coated members 2 are repeatedly heated and cooled several timed while the rotary device 3 makes one rotation, so that drying of the coating films 8 and 9 is facilitated as well as the drying time is shortened. In addition, since five of the coated materials 2 are attached to the rotary device 3 on the same track, higher productivity is achieved compared to the conventional coating film drying method. Further, production costs are reduced because expensive equipments are not required.

Since an odd number of the coated materials 2 is attached to the rotary device 3, the coating film 9 that appears at the inner peripheral side of the rotary device 3 is also radiated by the preliminary heating device 4 while the coated members 2 attached to the rotary device 3 are rotated once. Accordingly, the coating film 8 that appears at the outer peripheral side of the rotary device 3 is dried without reversing the coating films 8 and 9, thereby improving productivity.

Drying is facilitated by applying the waterborne coating consisting primarily of acrylic emulsion and forming one-liquid type cold-setting waterborne coating hardening at a temperature ranging from 70 degrees Celsius to 90 degrees Celsius and by radiating mid-infrared rays or near infrared rays while the coated member 2 is rotated, so that the drying time is shortened.

Moreover, in the clear-coating application process, the curing agent consisting primarily of isocyanate is blended in the main agent consisting primarily of acrylic urethane, thereby forming a two-liquid type cold-setting solvent coating hardening at a temperature ranging from 70 degrees Celsius to 90 degrees Celsius. Afterwards, the two-liquid type cold-setting solvent coating is applied to the coated member 2. Since the coating film drying method includes the clear-coating application process provided between the preliminary drying process and the final drying process, a clear coating of the cold-setting solvent coating is applied to coating films formed of the waterborne coating.

As explained above, according to the subject matter of the method for drying the coating film, the coated films 8 and 9 are preliminarily dried by repeatedly heating and cooling the coated member 2 in the preliminarily drying process while rotated by the rotary device 3 at a predetermined frequency (for example a frequency raging from 0.1 Hz to 20 Hz). Consequently, drying of the coating films 8 and 9 are facilitated without occurrence of popping defects and the drying time is shortened. The reason why the drying time of the coating films 8and 9 are shortened by repeatedly heating and cooling the coated member 2 will be explained as follows. A temperature amplitude (a higher temperature side) in the case of the coating film drying method of the embodiment where the coated member 2 is repeatedly heated and cooled and then dried while being rotated, is 5 degrees Celsius higher (a higher temperature side) than a temperature amplitude (a higher temperature side) in the case of the conventional coating film drying method where the coated member 2 is dried while being fixed. In this case, a maximum water vapor pressure in the coating film drying method of the embodiment is increased approximately by 25%. Drying of water contained in the coating films 8 and 9 are in correlation with the maximum water vapor pressure. When the coating films 8 and 9 are heated with a heating device such as infrared waves, the temperature of the water contained in the coated films 8 and 9 increases. As the temperature increases, the maximum water vapor pressure increases. When the maximum water vapor pressure is high, pressure applied to the water contained in the coated films 8 and 9 increases, so that volatilization of the water contained in the coated films 8 and 9 is facilitated and so that the coating films 8 and 9 are dried. At this time, the temperature of the plastic material or the like included in the work 13 for the coated member 2 is controlled to be lower than a higher temperature in the temperature amplitude by repeatedly heating and cooling. Accordingly, the temperature of the coated member 2 is controlled so as not increase while the coating films 8 and 9 are dried without occurrence of popping defects, so that thermal deformation of the coated member 2 and the work 13 due to high temperatures is prevented and dimensional defects are also prevented.

In the coating film drying method according to the embodiment, a preliminary drying device 1 is used in the coating film drying method, the preliminary drying device 1 includes a rotary device 3 for rotating the coated member 2 and a preliminary heating device 4 for heating the coating films 8 and 9 of the coated member 2, wherein a distance between the coated member 2 and the preliminary heating device 4 is varied when the coated member 2 is rotated by the rotary device 3 at the predetermined frequency, whereby the coated member 2 is repeatedly heated and cooled.

Accordingly, when the coated member 2 is rotated by the rotary device 3 in the preliminary drying process, a required distance between the coated member 2 and the heating device 4 for uniformly heating the coating films 8 and 9 is shortened from a length ranging from 300 mm to 500 mm when the coated member 2 is not rotated to a length ranging from 30 mm to 100 mm when the coated member 2 is rotated. Consequently, when the coated member 2 is rotated by the rotary device 3, the coated member 2 is approximated to the preliminary heating device 4 in the range from 300 mm to 500 mm, thereby minimizing the preliminary drying device 1. In addition, expensive equipment for covering the coated member 2 with an airtight metal container and required when microwaves are applied, is not required. Moreover in the coating line operated by the conveyor manufacturing system, it is possible to process the coated member 2 in the line without taking out the coated member 2 from the line, therefore securing higher productivity compared to the conventional coating film drying method. Further, expensive equipment is not required compared to the conventional coating film drying method, so that production costs are reduced.

In the coating film drying method according to the embodiment the rotary device 3 rotates so that the coated member 2 is rotated at a speed ranging from 40 mm per second to 400 mm per second relative to the preliminary heating device 4.

Accordingly, the rotary device 3 rotates so that the coated member 2 is rotated at a speed ranging from 40 mm per second to 400 mm per second relative to the preliminary heating device 4. When the coated member 2 is rotated at the speed ranging from 40 mm per second to 400 mm per second relative to the preliminary heating device 4, cooling is lightly affected by convection created by rotation of the coated member 2 and the nonvolatile content (NV: nonvolatile content during a preliminary heating process) of each of the coating films 8 and 9 is maintained to 70 percent or more. The nonvolatile content of 70% is generally a suitable percentage for a preliminary drying process.

In the coating film drying method, the coated member 2 is heated by the preliminary heating device 4 with mid-infrared rays or near infrared rays and is preliminarily dried.

Accordingly, since mid-infrared rays or near infrared rays are easily absorbed in waterborne coatings, it is possible to heat water in the coating films 8 and 9. Consequently, drying of the coating films 8 and 9 is facilitated without occurrence of popping defects and the drying time is shortened. Moreover, since the coated member 2 is heated by radiant heat of the mid-infrared rays, the temperature of the coated member 2 increases from the surface in comparison to the conventional coating film drying method in which water in the coating films 8 and 9 is totally heated from within. Accordingly, the temperature of the plastic material included in the work 13 for the coated member 2 is prevented from increasing. Consequently, thermal deformation of the work 13 is prevented, thereby preventing dimensional defects.

In the coating film drying method according to the embodiment, the plurality of the coated members 2 is attached to the rotary device 3 on the same track, the plurality of the coated members 2 is heated by a plurality of the preliminary heating devices 4 and is preliminarily dried.

Since the plurality of the coated members 2 is attached to the rotary device 3 on the same track and heated by the plurality of the preliminary heating devices 4, the coated members 2 are repeatedly heated and cooled several times while the rotary device 3 makes one rotation. Accordingly, drying of the coating films 8 and 9 of the coated members 2 is facilitated as well as the drying time is shortened. In addition, since the plurality of the coated members 2 is attached to the rotary device 3 on the same track, higher productivity is achieved compared to the conventional coating film drying method. Further, production costs are reduced because expensive equipments are not required.

In the coating film drying method according to the embodiment, an odd number of the coated members 2 is attached to the rotary device 3.

Since the odd number of the coated members 2 is attached to the rotary device 3, the coating film 9 that appears at the outer peripheral side of the rotary device 3 is radiated by the preliminary heating device 4 while the coated members 2 attached to the rotary device 3 are rotated once. Accordingly, the coating films 8 that appears at the outer peripheral side of the rotary device 3 and the coating film 9 that appears at the inner peripheral side of the rotary device 3 are dried without reversing the coating films 8 and 9, therefore improving productivity.

In the coating film drying method according to the embodiment, the waterborne coating is a cold-setting waterborne coating.

Accordingly, drying with mid-infrared rays or near infrared rays is facilitated by applying the waterborne coating consisting primarily of acrylic emulsion and forming one-liquid type cold-setting waterborne coating which hardens at a temperature ranging from 70 degrees Celsius to 90 degrees Celsius, so that the drying time is shortened.

The coating film drying method further includes a clear-coating application process for applying the cold-setting waterborne coating to the coated member 2 between the preliminary drying process and the final drying process.

In the clear-coating application process, the curing agent consisting primarily of isocyanate is blended in a main agent consisting primarily of acrylic urethane, thereby forming a two-liquid type cold-setting solvent coating hardening at a temperature ranging from 70 degrees Celsius to 90 degrees Celsius. Afterwards, the two-liquid type cold setting solvent coating is applied to the coated member 2. Since the coating film drying method includes the clear-coating application process between the preliminary drying process and the final drying process, a clear coating of the cold-setting solvent coating is applied to coating films formed of the waterborne coating.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A coating film drying method comprising:
a coating process for applying a waterborne coating to a work and forming a coating film on the work, so that a coated member is produced from the work having the coating film;
a preliminary drying process for heating the coated member and preliminarily drying the coated member until a nonvolatile content of the coating film reaches a percentage ranging from 70% to 90%;
a final drying process for heating and drying the coated member until the nonvolatile content of the coating film reaches a percentage of 97% or more; and
a cooling process for cooling the coated member until a surface temperature of the coated member is decreased to a temperature at which the coated member is touchable by hand, whereby the preliminary drying process is carried out by repeatedly heating and cooling the coated member at a predetermined frequency to preliminarily dry the coating film.

2. The coating film drying method according to claim 1, wherein a preliminary drying device is used in the coating film drying method, the preliminary drying device includes a rotary device for rotating the coated member and a preliminary heating device for heating the coating film of the coated member, wherein a distance between the coated member and the preliminary heating device is varied when the coated member is rotated by the rotary device at the predetermined frequency, whereby the coated member is repeatedly heated and cooled.

3. The coating film drying method according to claim 2, wherein the rotary device rotates so that the coated member is rotated at a speed ranging from 40 mm per second to 400 mm per second relative to the preliminary heating device.

4. The coating film drying method according to claim 2, wherein the coated member is heated by the preliminary heating device with mid-infrared rays or near infrared rays and is preliminarily dried.

5. The coating film drying method according to claim 2, wherein a plurality of the coated members is attached to the rotary device on the same track, the plurality of the coated members is heated by a plurality of the preliminary heating devices and is preliminarily dried.

6. The coating film drying method according to claim 5, wherein an odd number of the coated members is attached to the rotary device.

7. The coating film drying method according to claim 1, wherein the waterborne coating is a cold-setting waterborne coating.

8. The coating film drying method according to claim 1, further comprises a clear-coating application process for applying the cold-setting waterborne coating to the coated member between the preliminary drying process and the final drying process.
